(19) United States
(12) Patent Application Publication
(10) Pub. No.: US 2023/0196484 A1
(43) Pub. Date: Jun. 22, 2023

(54) SYSTEMS, METHODS AND MACHINE READABLE PROGRAMS FOR PERFORMING REAL ESTATE TRANSACTIONS

(71) Applicant: Stake Network, Inc., Seattle, WA (US)

(72) Inventors: Rowland Hobbs, New York, NY (US); James Jacobson, New York, NY (US)

(21) Appl. No.: 18/149,084

(22) Filed: Dec. 31, 2022

Related U.S. Application Data
(63) Continuation of application No. PCT/US22/79076, filed on Nov. 1, 2022.
Application No. PCT/US22/79076 is a continuation-in-part of application No. 16/581,107, filed on Sep. 24, 2019, now abandoned.
(60) Provisional application No. 63/274,187, filed on Nov. 1, 2021.
(60) Provisional application No. 62/735,695, filed on Sep. 24, 2018.
(60) Provisional application No. 62/736,599, filed on Sep. 26, 2018.

(51) Int. Cl. G06Q 50/16; G06Q 30/0645; G06Q 30/0226; G06Q 40/06

(52) U.S. Cl. CPC G06Q 50/163; G06Q 30/0645; G06Q 30/0231; G06Q 40/06

(57) ABSTRACT

Certain aspects of the disclosure are directed toward systems methods and computer readable media containing machine readable programs thereon for managing real estate.

### CROSS-REFERENCE TO RELATED APPLICATIONS

The present patent application is a continuation of and claims the benefit of priority to International Application No. PCT/US22/79076, filed Nov. 1, 2022, which in turn claims the benefit of priority to U.S. Provisional Patent Application No. 63/274,187, filed Nov. 1, 2021. The present patent application is a continuation-in-part of and claims the benefit of priority to U.S. patent application Ser. No. 16/581,107, filed Sep. 24, 2019, which in turn claims the benefit of priority to U.S. Provisional Patent Application Ser. No. 62/735,695 filed Sep. 24, 2018 and U.S. Provisional Patent Application Ser. No. 62/736,599 filed Sep. 26, 2018. Each of the foregoing patent applications is incorporated by reference herein in its entirety for any purpose whatsoever.

### FIELD OF THE DISCLOSURE

The disclosed embodiments relate to a computing device with an improved real-estate user interface. The term ‘computing device’ refers to any kind of device which can process and display information. The aspects of the disclosed embodiments have specific application to mobile computing devices. The term ‘mobile computing device’ refers to any kind of mobile device with communications capabilities and includes radio (mobile) telephones, smart phones, communicators, PDAs and wireless information devices. The aspects of the disclosed embodiments also have specific application to desktop computers, or other non-mobile computing devices. The term ‘desktop computer’ refers to any kind of A desktop computer is a personal computer designed for regular use at a single location on or near a desk or table due to its size and power requirements. The most common configuration has a case that houses the power supply, motherboard (a printed circuit board with a microprocessor as the central processing unit (CPU), memory, bus, and other electronic components), disk storage (usually one or more hard disk drives, optical disc drives, and in early models a floppy disk drive); a keyboard and mouse for input; and a computer monitor, speakers, and, often, a printer for output. The case may be oriented horizontally or vertically and placed either underneath, beside, or on top of a desk. Specifically, the invention provides an improved interface accessible on a computing device, which provides users with a versatile and efficient tool for matching renters with homes and income, and matching owners with renters and cost savings. It facilitates the display of and projection of real-estate investment values traded on a blockchain.

### BACKGROUND

The ownership and management of real estate provides continuing challenges for owners and property managers. The present disclosure is directed to improvements on the state of the art in rental property management, as set forth below.

### SUMMARY OF THE DISCLOSURE

Owners of housing units spend large amounts of money trying to acquire renters, and renters move more often, which results in an increase in lost expenses for owners. Similarly, tenants lose money by renting through a variety of mechanisms. Deposits tie-up free cash each time the tenant moves to a new residence, and climbing rental prices may leave tenants with monthly rental expenses which are up to 50% of take-home income. Accordingly, renters lose money each month and can't work towards long-term financial goals.

The purpose and advantages of the present disclosure will be set forth in and become apparent from the description that follows. Additional advantages of the disclosed embodiments will be realized and attained by the methods and systems particularly pointed out in the written description hereof, as well as from the appended drawings and patent applications incorporated by reference herein.

To achieve these and other advantages and in accordance with the purpose of the disclosure, as embodied herein, in one aspect, the disclosure includes embodiments of a method, machine readable program, and computing system to manage renters in a rental relationship with an owner, landlord or management company.

An illustrative computing device includes one or more computer processor circuits and one or more non-transitory machine readable storage mediums storing a set of instructions that when executed by the one or more computer processor circuits, cause the computing device to receive at least one renter data input relating to renter behavior, analyze the at least one renter data input via processor, and determine at least one action to take based on the analysis.

In some implementations, the at least one action includes providing a recommendation to a landlord identifying at least one action to take based on the analysis. For example, the recommendation can be based on data collected across a group of renters in at least one property owned by the landlord. The recommendation can include a recommendation for providing a cash reward to at least one renter.

In another embodiment, the least one action recommended by the computing device can include providing a recommendation to a renter identifying at least one action to take based on the analysis. For example, the at least one action can include the renter setting a goal, and the instructions can cause the computing device to present the renter with a user interface to set the goal. If desired, the user interface can permit the renter to select a goal from a predetermined selection of goals, and (ii) responsive to the renter setting the goal, the instructions can cause the computing device to send the renter information on how to help achieve the goal.

In some implementations, the at least one renter data input can include information evidencing that the renter did not pay rent on time. The goal suggested to or selected by the renter can include paying rent on time in the future. The machine readable system instructions can cause the computing device to send the renter information to help the renter to save money. If desired, the renter can be provided with a cash reward for setting the goal. In accordance with further aspects of the disclosure, the renter can be provided with a further cash reward for saving money, or making an on-time rental payment, or for taking other actions.

In some implementations, the at least one renter data input relating to renter behavior can include financial data extracted from digitized financial transaction information. For example, the financial data can include at least one of vendor information for a purchase made by the renter that identifies the vendor, and stock keeping unit (“SKU”) information that identifies at least one item purchased by the renter. If desired, the least one action to take can include, for example, providing a recommendation to provide a cash reward to the renter in the form of a gift card for use with a vendor selected based at least in part on the vendor information or the SKU data.

The at least one renter data input can include information indicating that the renter has taken an action requested by the system, and in response the system may execute a transaction to provide financial reward to the renter for taking the action. The action taken by the renter resulting in the financial reward can include, for example, one or more of (i) referring a prospective tenant to a landlord, (ii) signing a new lease, (iii) renewing a lease, (iv), providing proof of renter insurance, (v) paying rent on time, (vi) improving their credit score, (vii) taking a tour of a residence, (viii) submitting an application for renting a residence, (ix) achieving a predetermined savings target, (x) responding to a rental listing, (xi) engaging in a rental showing, (xii) for connecting a financial institution account to a user account of the renter, (xiii) for engaging in a community activity, (xiv) for reducing utility usage, (xv) maintaining renter insurance for a predetermined period of time, (xvi) activating a debit card through an issuer, and (xvii) activating a checking account through an issuer.

In some implementations, the (i) timing, (ii) magnitude, and/or (iii) type of the financial reward can be selected or adjusted based on criteria determined by analysis of renter behaviors. Such criteria can include, among other things, the advertised or asking rent for a residence, the per square cost for a residence, the occupancy rates of units in the property, and in the local market, lease trade outs in a property, delinquency rates of the renter or renters in a property, the end date of a lease, and how soon lease renewals are signed before lease expiration.

In some implementations, the reward is selected by analyzing the connection between the renter and a plurality of outcomes, or prospective rewards, in a graph database.

In various embodiments, the timing, magnitude, or type of the financial reward can be selected based on the analysis of renter behaviors in order to drive a desired outcome. The timing, magnitude, and/or type of the financial reward can be selected based on the analysis of renter behaviors in order to reduce delinquency in rental payments. If desired, the reward can be selected based on previous purchasing patterns of the renter.

In further implementations, computing devices, methods and machine readable programs are provided for inducing renters to perform a desired task. An illustrative system for doing so can include, for example, one or more computer processor circuits and one or more non-transitory machine readable storage media storing a set of instructions that when executed by the one or more computer processor circuits, cause the computing device to select a task to be performed by a renter, and prepare and forward a request to the renter to perform the task.

If desired, the request can include instructions for performing the task. Instructions can further be provided to process task completion data received from the renter via processor. Instructions can further be provided to provide a reward to the renter responsive to receipt of the task completion data. In some implementations, the reward can be provided automatically in response to receiving the task completion data. The task completion data can include a photograph evidencing completion of the task including a time stamp and geocoordinates for where the photo was taken, among other things. Instructions can further be provided to initiate payment to the renter of a reward if the geocoordinates or time stamp meet predetermined criteria associated with the maintenance task. In some implementations, the task completion data can include data obtained by the renter from a QR code at a location where the maintenance task was performed.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the method and system of the disclosure. Together with the description, the drawings serve to explain the principles of the disclosed embodiments.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIGS. 1-7 illustrate examples of GUI screens illustrating aspects of systems in accordance with the disclosure.

FIG. 8 illustrates a topology of a payment system in accordance with the present disclosure.

FIG. 9 shows a block diagram illustrating an exemplary system in one embodiment of the disclosure.

### DETAILED DESCRIPTION

The vicious cycle of renters leaving and owners finding new ones increases costs for all. Owners spend money trying to acquire renters, such as spending money on brokers, marketing, and concessions like a “free month of rent” which may cost up to 30% of the first year of rent. Today, renters move more often, resulting in more lost expenses for owners. Furthermore, the longer that property is empty, the more it costs. Most new leases are not profitable until the last month. Therefore, even one month of an empty unit (e.g., a housing unit or other type of real-estate unit) can make the difference of being profitable. Similarly, renters have every reason to move. Offers such as “free month of rent” reward renters for moving. At the end of that year rent goes up and renters move again. Deposits tie-up free cash and rent is up to 50% of take-home income. As such, renters lose money each month and can't save for the things they need.

Various resources are focused on acquiring and managing renters, neglecting retaining renters. The disclosed embodiments can act as a loyalty program, rewards program, cash-back, or overall retention marketing program.

In accordance with the present disclosure, methods, systems and machine readable programs are provided to improve tenant retention. Applicant has come to appreciate that property owners and managers do not typically have sufficient information on renter behavior, let alone manage that information to create pathways to enhance tenant retention. When a property owner goes to raise capital, it is helpful to be able to show that they have reliable tenants with low turnover, as this can present a lower risk investment to a potential lender.

In accordance with the present disclosure, a computing device implementing machine learning can collect information to better retain renters based on goals provided by the renters. For instance, an interface and artificial intelligence (AI) can be used to provide recommendations on the amount, timing and type of tenant reward based on user indicated goals and collected data points. User indicated goals may include financial goals such as short term plans to save, long term plans to invest; location goals; or experiential goals such as view or amenities. Additionally, user-indicated goals may include price such as what the particular user can afford, to pricing changes during the course of being a member/tenant. Moreover user-indicated goals may include life-events including marriage, a job change, and birth of children, among others.

Use of artificial intelligence, and more specifically machine learning (a subset of artificial intelligence), facilitates the development of algorithms that engage tenants of rented housing units to better understand their interests and goals. These algorithms may analyze and interpret a mix of data points (financial, occupational, location, goals, current arrangement, and demographic trends) to predict a timing, type and magnitude of a reward to cause or encourage a tenant to take one or more actions.

An illustrative computing device includes one or more computer processor circuits and one or more non-transitory machine readable storage mediums storing a set of instructions that when executed by the one or more computer processor circuits, cause the computing device to receive at least one renter data input relating to renter behavior, analyze the at least one renter data input via processor, and determine at least one action to take based on the analysis.

In some implementations, the at least one action includes providing a recommendation to a landlord identifying at least one action to take based on the analysis. For example, the recommendation can be based on data collected across a group of renters in at least one property owned by the landlord. The recommendation can include a recommendation for providing a cash reward or other reward to at least one renter.

For purposes of illustration, and not limitation, the recommendation can include an action for a tenant to take that affects the renter's desirability as a tenant. For example, in one illustration, the at least one renter data input may include information evidencing that the renter did not pay rent on time. This information can be determined by monitoring the landlord's or management company's bank account. The system can query account information from the landlord's bank account and parse the information to search for an incoming payment that bears indicia in the data of the renter's checking account that is typically used to pay the rent. Failure to detect such a transaction within a predetermined time period, such as several days, of the rental payment deadline can automatically trigger the system to prepare and send a message (e.g., email, SMS text, or the like) to the tenant informing them that their rent was not received on time, and providing one or more recommendations to help the renter manage their finances to help avoid being late in future payments.

The goal suggested to or selected by the renter can include paying rent on time in the future. The machine readable system instructions can cause the computing device to send the renter information to help the renter to save money. If desired, the renter can be provided with a cash reward for setting the goal. In accordance with further aspects of the disclosure, the renter can be provided with a further cash reward for saving money, or making an on-time rental payment, or for taking other actions. Similarly, based on information collected by the system on the renter's shopping patterns, the system can search the internet for discounts and coupons for vendors that the renter frequents, and forward the discounts to the renter to help them manage their finances and save money.

In some implementations, the at least one renter data input relating to renter behavior can include financial data extracted from digitized financial transaction information. For example, the financial data can include at least one of vendor information for a purchase made by the renter that identifies the vendor, and stock keeping unit (“SKU”) information that identifies at least one item purchased by the renter. If desired, the least one action to take can include, for example, providing a recommendation to provide a cash reward to the renter in the form of a gift card for use with a vendor selected based at least in part on the vendor information or the SKU data. The system can be configured, for example, to compare the price paid for the good or service to competitors, and if lower priced services or goods are identified, a notification can be sent to the renter of a better deal for the next time they make such a purchase.

The at least one renter data input relating to renter behavior can include data extracted from a social media platform that can be parsed by the system. For example, a renter can be encouraged to form a social media platform connection (e.g., accept a Facebook® friend request) from the rental management company that manages the renter's apartment building. The system can periodically query the user's page, and/or parse push notifications from the social media platform and analyze the data to identify at least one interest of the renter. For example, the system can parse geolocation and timing coordinates on photos uploaded by the user to the social media platform to identify the location and time the photo was taken. For example, if a photo is taken and posted on social media by the renter at a restaurant, the system can parse the social media post first for a text notation by the user naming the restaurant. But, if sufficient detail is not provided in text form by the poster, the system can analyze the photo for geo coordinates embedded with the photo and time stamp information, and correlate the geo coordinates with a map indicating vendors in that location. Thus, if the keywords “dinner” or “meal” are detected, the system can make a determination, based on geo coordinates, that the poster is located at the restaurant. Similarly, the geocoordinates based on any photo can be used to estimate the interest of a renter. Thus, as a reward, for any reason as set forth herein, the system can send the renter a reward in the form of a gift card for the restaurant.

Moreover, other data can be parsed by the system such as the renter's friend's list. The friend list can be cross-referenced by the system to a public database, such as a phone number database to identify the addresses of the friends of the user. From this data, the system can identify addresses where the renter's friends live. By determining the address information, the system can identify which of the user's social media friends live in rental buildings. Based on this and/or other information, the system can make a recommendation to the renter to suggest having a friend apply for an apartment that is becoming available in the building. If the user sends an invitation to the friend, and sends proof to the system that the friend has been contacted, the system can reward the friend. Alternatively, the system can ask the renter to issue an invitation to the social media friend through the platform to make them aware of the apartment. The renter can be provided with a reward for the initial referral, and if the friend tours the apartment, and/or if the friend signs a lease. If the friend moves in after signing a lease, the system can prepare and forward a communication to the renter to suggest a welcome gift for the friend as a surprise. Moreover, social media platform data can be leveraged to identify connections between a renter and their contacts. It is possible that close contacts of the renter are also suitable and reliable tenants. Moreover, having a renter's tenants in the same apartment complex is likely to encourage the tenant to stay in the apartment, and reduce the chances of the unit not being occupied.

In further implementations, the at least one renter data input can include information indicating that the renter has taken an action requested by the system, and in response the system may execute a transaction to provide financial reward to the renter for taking the action. The action taken by the renter resulting in the financial reward can include, for example, one or more of (i) referring a prospective tenant to a landlord (described above), (ii) signing a new lease, (iii) renewing a lease, (iv), providing proof of renter insurance, (v) paying rent on time, (vi) improving their credit score, (vii) taking a tour of a residence, (viii) submitting an application for renting a residence, (ix) achieving a predetermined savings target, (x) responding to a rental listing, (xi) engaging in a rental showing, (xii) for connecting a financial institution account to a user account of the renter, (xiii) for engaging in a community activity, (xiv) for reducing utility usage, (xv) maintaining renter insurance for a predetermined period of time, (xvi) activating a debit card through an issuer, and (xvii) activating a checking account through an issuer.

In some implementations, the (i) timing, (ii) magnitude, and/or (iii) type of the financial reward can be selected or adjusted based on criteria determined by analysis of renter behaviors. Such criteria can include, among other things, the advertised or asking rent for a residence, the per square cost for a residence, the occupancy rates of units in the property, and in the local market, lease trade outs in a property, delinquency rates of the renter or renters in a property, the end date of a lease, and how soon lease renewals are signed before lease expiration.

For example, in the instance of a lease coming up for a renewal, the value or amount of a reward, such as a cash reward, can be set based on market conditions. If the building is in high demand and the landlord believes they can get more rent for the unit, it may be desirable to not entice the existing tenant to stay if the existing tenant does not want to pay the higher rent. But, if there are a significant amount of empty units, or if it is a time of year that is difficult to obtain a reliable tenant, such as winter time, or in the event the landlord will be seeking financing and needs to maximize occupancy, an award can be provided that is significant in magnitude. But, the magnitude of the award can be based at least in part on actual data collected about the particular renter or other renters in the building. Thus, if in past experience only a reward above a certain magnitude was sufficient to entice a tenant to renew their lease during a given time of the year, the renter can be provided with an amount above that amount. Similarly, if the renter is “off cycle” in the sense that the renter's lease begins and ends in the dead of winter, the system can recommend to the landlord that an extension be offered in the lease to warmer months to permit the tenant, and the landlord, to be “on cycle” to permit the lease to end when more renters are generally looking for a new rental unit.

In some implementations, identifying meaningful, but potentially hidden, connections, between a renter and a desired outcome, such as identifying inducements to retain the tenant, cane be accomplished by identifying multiple meaningful pathways connecting the entities within a database such as a graph database and/or a relational database. In some other implementations, the method can determine a relative importance score of entities within the database with regard to one another.

For purposes of illustration, and not limitation, in one embodiment of a system in accordance with the disclosure, a user, such as a landlord or property manager may utilize an embodiment of the disclosed system to analyze, and quantify, the relevance of a first element, such as a renter with respect to a second element, such as a vendor (e.g., restaurant or store) that is nearby to determine a relevance score of the renter with respect to the vendor. This process can be repeated for a plurality of renters with respect to a plurality of vendors to determine a relatively high relevance score, with the objective of identifying a vendor the renter frequents to provide the renter with a reward to the vendor as an inducement to make the tenant stay in the rental unit. The property manager may input the name of the renter and the vendor, which are associated with nodes N1, N2 in a database, such as a graph database, relational database, or other database structured to recognize relations between the renters and the vendors, into a system provided in accordance with the disclosure. The property manager may then specify desired criteria C1, C2, C3 that could be used to link the renter to the vendor, such as whether the renter has been known to frequent the vendor (from back transaction data, for example), whether the renter's social media contacts frequent the vendor, whether the renter's phone geocoordinates have overlapped with the location of the vendor, and the like. When actuated based on these inputs, the system then analyzes the relevance of the renter with respect to the vendor based on the criteria, and then may show a graphic that quantifies the relevance of the renter with respect to the vendor, evidencing direct, and more attenuated, or hidden, relevancies. For example, even though the renter's bank data may not evidence a transaction, the geolocation data of the renter and their friends may all coincide at the vendor at the same time, wherein it could be surmised that although the renter was present at a restaurant, they may have not paid the bill, but may still favor the restaurant. Or, the renter may have paid with cash. Thus, a graph database can be used to uncover subtle or hidden connections between a renter and a local vendor.

In operation, the information from the graph database can be directed to a server, which in turn generates a request for K (e.g., K=5) shortest paths between the document and the entity. This request is then directed to the graph database where the “K” shortest paths are generated in accordance with a desired algorithm. Any suitable algorithm can be used for determining shortest paths. For example, Yen's method can be used (Yen, Jin Y. (1970). “An algorithm for finding shortest routes from all source nodes to a given destination in general networks”. Quarterly of Applied Mathematics. 27: 526-530), which is expressly incorporated by reference herein in its entirety for any purpose whatsoever. Yen's algorithm computes single-source K-shortest loopless paths for a graph with non-negative edge cost.

This can be accomplished by first computing “K” shortest paths by utilizing Equation 1 below:

$$\{ {d}_{i} = {\sum }_{path i} ( 1 - w ) \} \qquad ( 1 )$$

Next, the total distance is calculated by summing the inverses of each of the “K” shortest paths into the total distance by utilizing Equation 2 below:

$${d}_{total} = {( {\sum }_{i = 0}^{K} \frac{1}{{d}_{i}} )}^{- 1} \qquad ( 2 )$$

The total distance specified above can, if desired, be used to quantify the relevance of the story to the company, but optionally an additional transform can take place. The total distance can be transformed into a relevance score between 0 and 100 by using Equation 3 below:

Relevance=100e^{-Kd}^{ₜₒₜₐₗ} (3)

By way of further example, Dijkstra's method for connecting two nodes with a shortest path can be used to calculate one or more of the shortest paths connecting nodes 222, 224 (Dijkstra, E. W. (1959). “A note on two problems in connection with graphs” (PDF). Numerische Mathematik. 1: 269-271), which is also expressly incorporated by reference herein in its entirety for any purpose whatsoever.

In this formulation, let the node at which we are starting be called the initial node. Let the distance of node Y be the distance from the initial node to Y. Dijkstra's algorithm will assign some initial distance values and will try to improve them step by step.

First, assign to every node a tentative distance value: set it to zero for the initial node and to infinity for all other nodes.

Second, set the initial node as current. Mark all other nodes unvisited. Create a set of all the unvisited nodes called the unvisited set.

Third, for the current node, consider all of its neighbors and calculate their tentative distances. Compare the newly calculated tentative distance to the current assigned value and assign the smaller one. For example, if the current node A is marked with a distance of 6, and the edge connecting it with a neighbor B has length 2, then the distance to B (through A) will be 6+2=8. If B was previously marked with a distance greater than 8 then change it to 8. Otherwise, keep the current value.

Fourth, when done considering all of the neighbors of the current node, mark the current node as visited and remove it from the unvisited set. A visited node will not be checked again.

Fifth, if the destination node has been marked visited (when planning a route between two specific nodes) or if the smallest tentative distance among the nodes in the unvisited set is infinity (when planning a complete traversal; occurs when there is no connection between the initial node and remaining unvisited nodes), then stop. The algorithm has finished.

Sixth, otherwise, select the unvisited node that is marked with the smallest tentative distance, set it as the new “current node”, and go back to the third step.

After computing “K” shortest paths, the shortest pathways and path lengths are determined within the graph database. The result is then outputted to the server, where the K path lengths are aggregated (e.g., via Equation 2 above), and the aggregate length is then transformed into a relevance score using Equation 3 above, for example.

In further implementations, computing devices, methods and machine readable programs are provided for inducing renters to perform a desired task. An illustrative system for doing so can include, for example, one or more computer processor circuits and one or more non-transitory machine readable storage media storing a set of instructions that when executed by the one or more computer processor circuits, cause the computing device to select a task to be performed by a renter, and prepare and forward a request to the renter to perform the task.

If desired, the request can include instructions for performing the task. Instructions can further be provided to process task completion data received from the renter via processor. Instructions can further be provided to provide a reward to the renter responsive to receipt of the task completion data. In some implementations, the reward can be provided automatically in response to receiving the task completion data. The task completion data can include a photograph evidencing completion of the task including a time stamp and geocoordinates for where the photo was taken, among other things. Instructions can further be provided to initiate payment to the renter of a reward if the geocoordinates or time stamp meet predetermined criteria associated with the maintenance task. In some implementations, the task completion data can include data obtained by the renter from a QR code at a location where the maintenance task was performed. The maintenance or other task can include replacing a filter on an air conditioning unit, unclogging a drain, replacing a light bulb, and the like.

In one embodiment of an interface, users agree in a graphical user interface to become a member of a loyalty program where the return can take a variety of forms. A server can track various parameters of the tenant over time, and make recommendations to a property manager or landlord based on machine learning. As such, the set of instructions executable by the one or more computer processor circuits may include instructions to receive as input from the particular user, the user-defined parameters including employment status, employer, financial goals, and particular amenities of interest, target rental price, family status, and long-term life goals.

In some example embodiments, the set of instructions executable by the one or more computer processor circuits includes instructions to identify geographic information associated with the particular user, indicating routes travelled and/or places frequently visited by the particular user.

A further interface includes building and community information, or “property management optimization”. Building and community information “property management optimization” may include a workflow to manage the rental experience with property management such as amenities, tenant requests, fixing broken equipment or damage in the apartment, moving preferences, services such as laundry, pet care, cleaning, etc. Based on user inputs, such as family size, job, career goals, education, and lifestyle preferences machine learning can make recommendations on how to use income. Notifications are delivered based on based on machine learning for the best time for the user, in a manner in which the notification is most likely to generate a productive outcome. In some example embodiments, the set of instructions executable by the one or more computer processor circuits includes instructions to monitor access data of the particular user, indicative of a day and time when the particular user accessed one or more of the application interfaces, and identify trends indicative of days and/or times of day during which the particular user accesses the one or more of the application interfaces. The computing device may then provide notifications to the particular user on the graphical user interface, the notifications including recommendations regarding real-estate investment and/or lifestyle changes during the identified days and/or times of day during which the particular user accesses the one or more of the application interfaces.

A further interface includes a workflow to manage rental concessions, discounts, marketing offers, and pricing in a real estate portfolio “loyalty engine”. Understanding financial needs of the unit matched with financial needs of the user and portfolio the computing device may prioritize units, offers, and incentives to maximize return for the landlord/manager. Accordingly, the computing device may assess the needs of the various renters in the program, and possible incentives available, to quickly and efficiently match a renter with an incentive which meets the user-defined parameters of the particular renter. The generated incentives, and/or incentive options may be presented to the landlord and/or renter via the graphical user interface.

Still a further interface includes a workflow to manage property performance across a real estate portfolio “pricing engine”. The pricing engine may track renter payments and prices against market rent and prices and make recommendations to optimize rent capabilities. For instance, the pricing engine, executed by the one or more computer processor circuits, may receive input such as local regulations, renter financial capabilities, and landlord financial goals. Using this information, the computing device may display on the graphical user interface, the identified recommendations to optimize rent.

Users can use the interface to initiate workflows to transfer funds from their rewards account with the owner/managing organization to an outside bank, or digital wallet. Those funds can be tied to a goal, selected by the user, in some implementations. As such, the set of instructions executable by the one or more computer processor circuits can include instructions to receive as input from a particular user, information on investment accounts, outside banks, and/or digital wallets associated with the particular user. The exit interface may allow the users to transfer funds from their real-estate investment portfolio, in a cryptocurrency, to a different investment in a non-digital currency and/or a cryptocurrency, and/or to transfer funds from their real-estate investment portfolio to a financial institution.

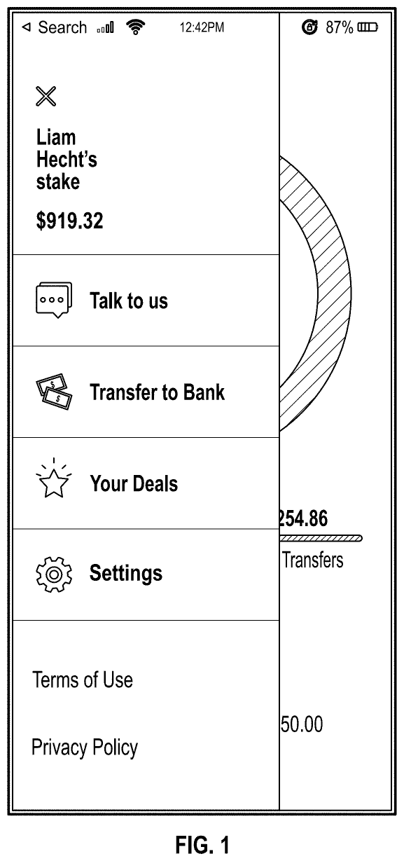

FIGS. 1-7 present illustrative implementations of graphical user interfaces that a renter may interact with of the system of the disclosed embodiments.

FIG. 1 presents a landing page or main page that a renter can interact with. A main menu is provided that includes an amount of money in the user's account. The money in the user's account can be moved to or from another financial institution. Cash rewards can be deposited by the landlord or property manager in the user's account. A menu selection is provided in the app to permit the renter to contact management for any of a variety of reasons. A link is provided to permit the user to perform a transfer, such as ACH to or from a financial institution. A rewards or deals feature can be selected on the GUI to provide the renter with one or more deals. The deals can be static or can be updated, and particular deal(s) can be curated for the renter based on their preferences and other metrics that the system collects over time.

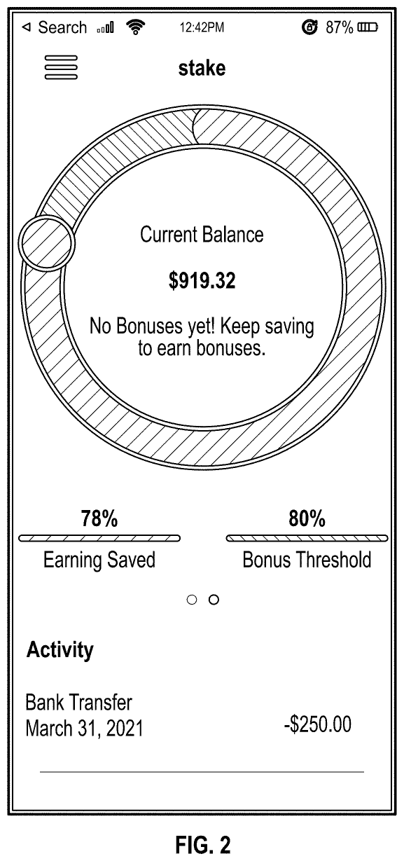

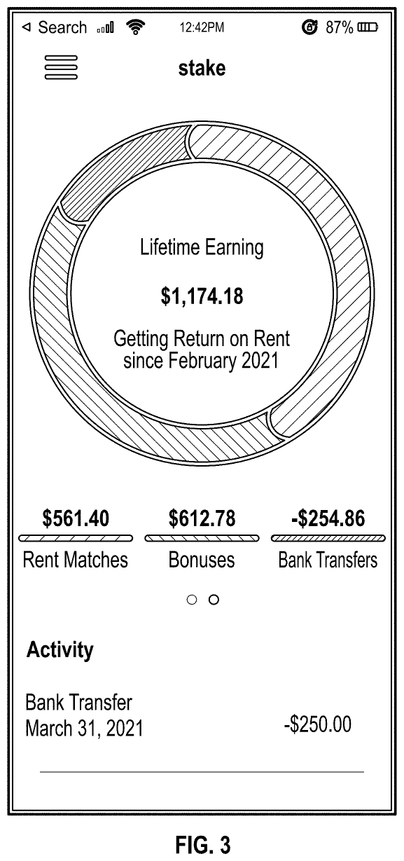

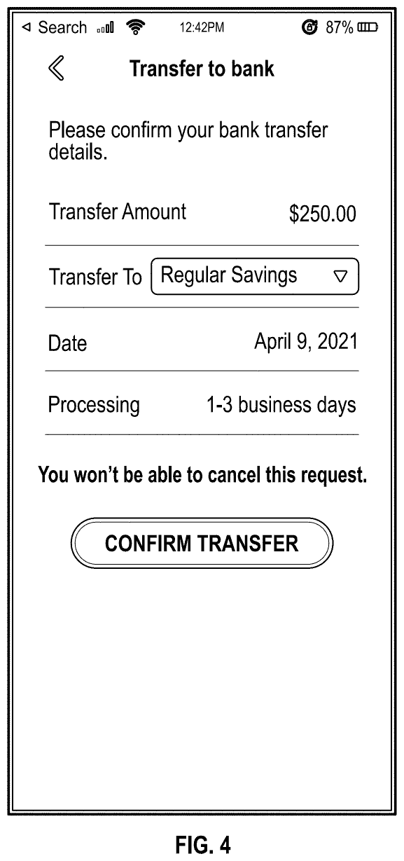

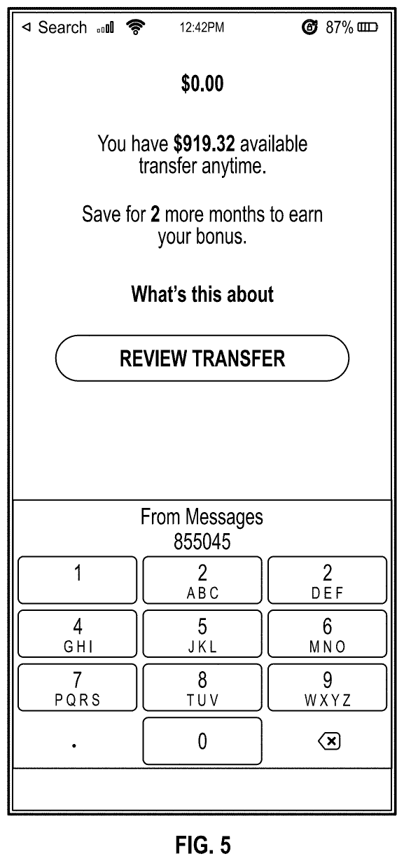

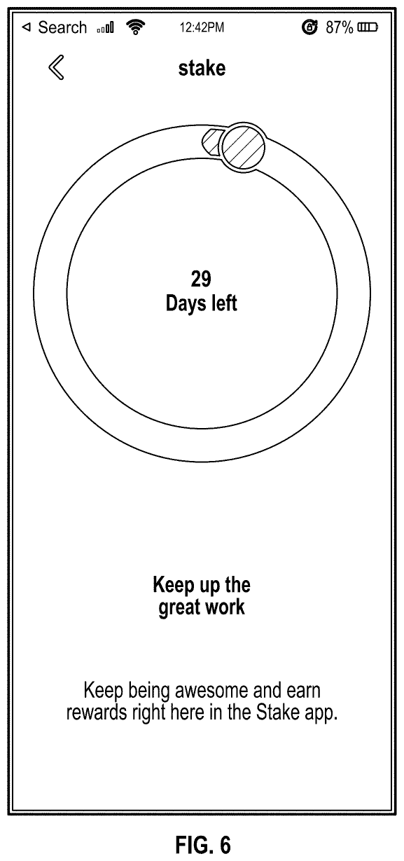

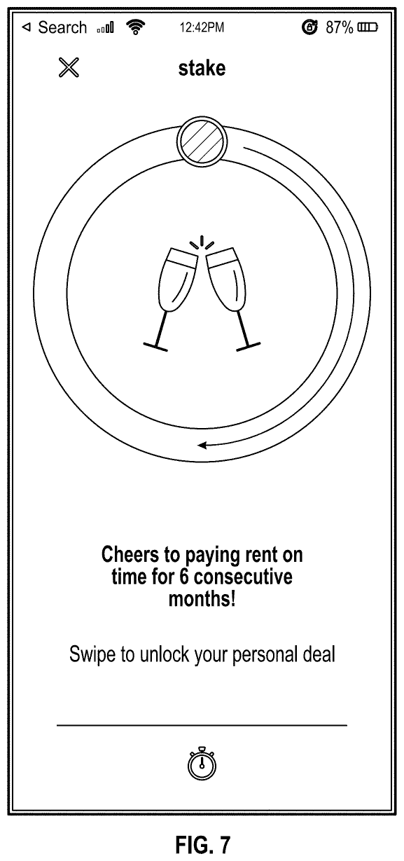

FIG. 2 presents a further GUI that can be displayed if a user selects the “Transfer to Bank” interface element of FIG. 1. As illustrated, an indicator is provided indicating the amount of money that has been paid in the account. The amount forming the scale of the GUI can correspond to a savings goal of the renter, such as the amount of one month's rent, and once a full month's rent is saved, the system can provide the renter with a further cash back reward. A field in the GUI can be provided that indicates the amount of cash back rewards the user has retained in their account on the platform. A transaction history is also illustrated at the bottom of the GUI of FIG. 2 indicating recent transactions. FIG. 3 presents a further GUI illustrating a breakdown of money that has flowed through the user's account, including rent matches, bonuses, and bank transfers. FIG. 4 presents a further GUI for processing a bank transfer from the renter's Stake™ account to an outside financial institution. FIG. 5 presents a GUI that summarizes the amount in the renter's Stake™ account and that informs the user how many more months the user has to save to obtain a bonus cash reward in their account for saving. FIG. 6 provides a further GUI indicating that a renter is closer to their savings goal, and FIG. 7 presents a GUI indicating that a renter has achieved their saving goal, resulting in a reward.

In some example embodiments, inputs from renters and/or members may be used for machine learning. For instance, data collection and predictive analytics may be used to determine when tenants want to stay in a unit (and therefore renew a lease), when tenants want to move (and therefore not renew a lease), and/or if moving, whether the tenant desires a larger or smaller unit, which neighborhood, etc. Similarly, data collection and predictive analytics may be used to determine which facilities tenants are using or not using (such as amenities offered by the residence), the delinquency rate for a typical renter, group of renters, or a particular renter, and the likelihood of a renewal of a lease. For instance, machine learning may be used to provide recommendations on housing unit pricing, ownership offers, and/or marketing options for renters to provide renters with incentives to renew their leases. Such machine learning processes may receive as input, data pertaining to location, facility usage, overall engagement, web browser activity, and historical performance of other comparable rewards, among other collectable data.

Each respective application interface may engage the user to collect data while artificial intelligence and/or machine learning algorithms (e.g., referred to herein as AI engines) generate content to be displayed on each respective interface. Various engines may decipher where someone might want to live considering a variety of data points, both internal and external, and may match renters with housing unit inventory across many owners.

The AI engines described herein may perform activities that humans could not perform in the current silo environment, and without digital engagements or interactions with renters. Existing solutions lack the ability to collect data in such a manner.

The AI engines may analyze and take automatic action through programmatic process automation. For instance, the AI engines may include, a pricing engine, a matching engine and a recommendation engine. Each engine may run on the operating system connected to interfaces and necessary third parties, such as payment gateways, brokerage accounts, property management systems, blockchain networks, distributed ledgers and wallets, among others. The pricing engine may include an algorithm (e.g., non-transitory machine readable instructions executable by a processing resource) for analyzing internal and external data to provide retail and wholesale pricing guidance. The matching engine may include an algorithm for analyzing member specific data (e.g., interface engagement, unit preferences, investment profile, rental application, location, etc.) to match renters with available units. The recommendation engine may include an algorithm for analyzing internal and external data (e.g., matching data, actions of other similar profiles and personas, geolocation data, demographics, demand, supply) to provide housing and personal finance recommendations and marketing offers (e.g., neighborhood, unit type, lease extension, furniture, vacations, moving, pet care, etc.).

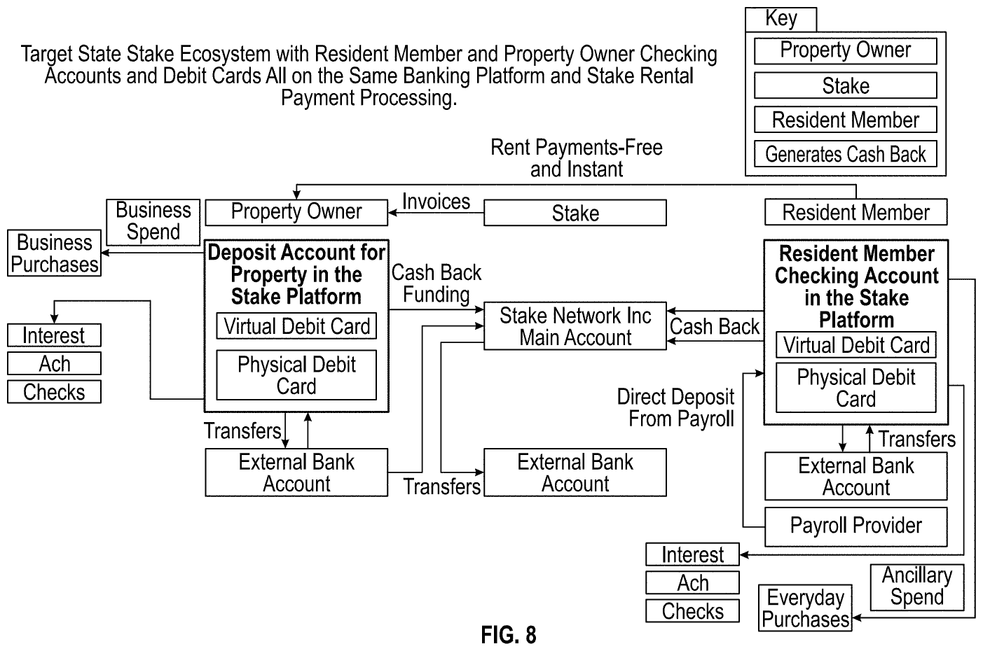

FIG. 8 presents a flow diagram describing the ways in which money is moved through an embodiment of the disclosed system. The color key indicates that the white elements relate to the property owner or property manager, the light grey elements relate to the renter, and the dark gray elements relate to accounts of the organization that facilitates renter engagement, such as a Stake™ system, which will be referred to herein as Stake. The Stake organization issues invoices to the Property Owner to pay for cash back rewards Stake pays to tenants, and for other services. The Stake business operating account receives payments for funding the cash rewards, and issues the cash back rewards to the renters. Renters pay the property owner rent payments directly in this embodiment, but this need not be the case. The renter member has an account outside of the Stake system that can be linked to the Stake account, or the Property Owner account. Not pictured in FIG. 8 are pathways between the Stake organization and third party payment providers such as Stripe™ and Plaid™, among others, such as banks. Financial transaction information can be routed from banks, payment services and the like to the Stake organization to populate the Stake database with metrics to analyze renter behaviors. Such data can also be routed from a user's mobile device if the user authorizes this activity.

Thus, the disclosed embodiments use proprietary data it collects and AI to help clients, such as property owners, determine an ideal Cash Back reward to incentivize renter behavior for a specific rental community. Various implementations request payment from clients, primarily the owners and operators of real estate, to fund their Cash Back rewards payments to their renters who will receive the Cash Back rewards for taking specific actions. Clients pay the Stake organization to fund the Cash Back rewards. Clients can pay via different methods including through Stake's proprietary Loyalty Cloud. Renters earn Cash Back from Stake when they take a desired behavior such as taking a tour of a residence, submitting an application for a residence, paying their rent on time, etc. The renter's action is recorded in Stake's Loyalty Cloud which determines the reward the renter has earned and when they should receive payment. At the appropriate time Stake transfers the Cash Back rewards, using the data in Loyalty Cloud, from Stake to the renter's Stake app account. Within the Stake app the renter connects their bank account to the Stake app.

After the renter connects their bank account to the Stake app, the renter can transfer their Cash Back rewards from their account in the Stake app to their bank account. Renters who are living in a Stake enabled residence can earn Cash Back rewards twice a month. The first-time renters can earn Cash Back rewards is for paying their rent each month. IF the renter pays their rent, they earn a Rent Match. The second time a renter can earn a Cash Back reward each month is if they achieve a pre-set savings target. If the renter hits this savings target, they earn their Savings Bonus Cash Back reward. Through Stake's growing network of partners, who offer value-add services and products to Stake renters, renters have additional opportunities to earn Cash Back rewards in their Stake app. The Loyalty Cloud can also be configured as a portal for property managers to configure their Rewards campaigns and to view campaign analytics.

### DETAILED DESCRIPTION OF THE COORDINATOR

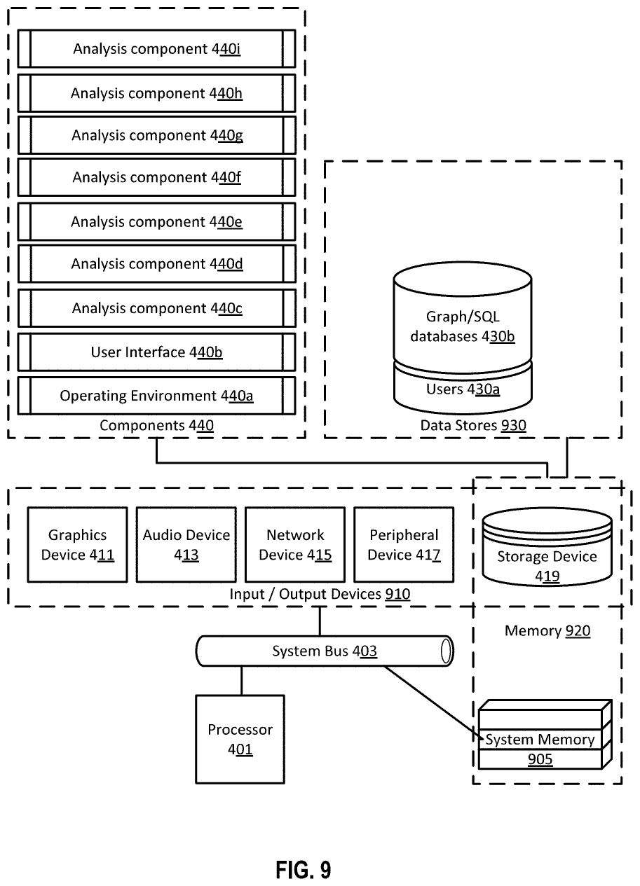

FIG. 9 shows a block diagram illustrating an exemplary coordinator in one embodiment of the disclosed embodiments. The coordinator facilitates the operation of the disclosed embodiments via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the coordinator may comprise a standalone computer system, a distributed computer system, a node in a computer network (i.e., a network of computer systems organized in a topology), a network of coordinators, and/or the like. It is to be understood that the coordinator and/or the various coordinator elements (e.g., processor, system bus, memory, input/output devices) may be organized in any number of ways (i.e., using any number and configuration of computer systems, computer networks, nodes, coordinator elements, and/or the like) to facilitate operation. Furthermore, it is to be understood that the various coordinator computer systems, coordinator computer networks, coordinator nodes, coordinator elements, and/or the like may communicate among each other in any number of ways to facilitate operation. As used in this disclosure, the term “user” refers generally to people and/or computer systems that interact with the; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; outside of the context of a graph database the term “node” refers generally to a server, to a client, and/or to an intermediary computer system, program, and/or a combination thereof that facilitates transmission of and/or handling of requests and/or responses.

The coordinator includes a processor 401 that executes program instructions. In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 405 via a system bus 403. The system bus may interconnect these and/or other elements of the coordinator via electrical, electronic, optical, wireless, and/or the like communication links (e.g., the system bus may be integrated into a motherboard that interconnects coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions executed by the processor. The system memory may facilitate accessing, storing, retrieving, modifying, deleting, and/or the like data by the processor.

In various embodiments, input/output devices 410 may be connected to the processor and/or to the system memory, and/or to one another via the system bus.

In some embodiments, the input/output devices may include one or more graphics devices 411. The processor may make use of the one or more graphic devices in accordance with program instructions executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data. A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 413. The processor may make use of the one or more audio devices in accordance with program instructions executed by the processor. In one implementation, an audio device may be a sound card that may obtain (e.g., via a connected microphone), process, output (e.g., via connected speakers), and/or the like audio data. A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 415. The processor may make use of the one or more network devices in accordance with program instructions executed by the processor. In one implementation, a network device may be a network card that may obtain (e.g., via a Category 5 Ethernet cable), process, output (e.g., via a wireless antenna), and/or the like network data. A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 417. The processor may make use of the one or more peripheral devices in accordance with program instructions executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the TRAILBLAZER coordinator with a variety of input, output and processing capabilities.

In some embodiments, the input/output devices may include one or more storage devices 419. The processor may access, read from, write to, store in, erase, modify, and/or the like a storage device in accordance with program instructions executed by the processor. A storage device may facilitate accessing, storing, retrieving, modifying, deleting, and/or the like data (e.g., graph database data as described elsewhere herein) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 405 and the one or more storage devices 419 may be referred to as memory 420 (i.e., physical memory).

Memory 420 contains processor-operable (e.g., accessible) data stores 430. Data stores 430 comprise data that may be used via the coordinator. Such data may be organized using one or more data formats such as one or more of a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, coordinator elements, and/or the like) to facilitate operation. For example, data stores may comprise data stores 430a-n implemented as one or more (e.g., graph) databases. A users data store 430a may be a collection of database tables that include fields such as UserID, UserName, UserPreferences, and/or the like. A graph database data store 430b may be a collection of graph databases.

System memory 420 contains processor-operable (e.g., executable) components 440. Components 440 comprise program components (including program instructions and any associated data stores) that are executed via the coordinator (i.e., via the processor) to transform inputs into outputs. It is to be understood that the various components and their subcomponents, capabilities, applications, and/or the like may be organized in any number of ways (i.e., using any number and configuration of components, subcomponents, capabilities, applications, coordinator elements, and/or the like) to facilitate operation. Furthermore, it is to be understood that the various components and their subcomponents, capabilities, applications, and/or the like may communicate among each other in any number of ways to facilitate operation. For example, the various components and their subcomponents, capabilities, applications, and/or the like may be combined, integrated, consolidated, split up, distributed, and/or the like in any number of ways to facilitate operation. In another example, a single or multiple instances of the various components and their subcomponents, capabilities, applications, and/or the like may be instantiated on each of a single coordinator node, across multiple coordinator nodes, and/or the like.

In various embodiments, program components may be developed using one or more programming languages, techniques, tools, and/or the like such as an assembly language, Ada, BASIC, C, C++, C #, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Web Socket Protocol, Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 440 may include an operating environment component 440a. The operating environment component may facilitate operation of the system via various subcomponents. In some implementations, the operating environment component may include an operating system subcomponent. The operating system subcomponent may provide an abstraction layer that facilitates the use of, communication among, common services for, interaction with, security of, and/or the like of various coordinator elements, components, data stores, and/or the like.

In some embodiments, the operating system subcomponent may facilitate execution of program instructions by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the system. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the system by providing user interface elements that may be used by the system to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate TRAILBLAZER capabilities such as storage, analysis, retrieval, access, modification, deletion, aggregation, generation, and/or the like of data (e.g., the use of data stores 1130). The database subcomponent may make use of database languages (e.g., Structured Query Language (SQL), XQuery), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, Apache Cassandra database, and/or the like.

In some implementations, the operating environment component may include an information handling subcomponent. The information handling subcomponent may provide the system with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, system components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 1130) via the database subcomponent.

In some embodiments, the information handling subcomponent may facilitate presentation of information obtained from users, system components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate system message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate system message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates system security. In some embodiments, the security subcomponent may restrict access to the system, to one or more services provided by the system, to data associated with the system (e.g., stored in data stores 430), to communication messages associated with the system, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the system may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates system virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 440 may include a user interface component 1140b. The user interface component may facilitate user interaction with the system by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In order to address various issues and advance the art, the entirety of this application (including the Cover Page, Title, Headings, Field, Background, Summary, Brief Description of the Drawings, Detailed Description, Claims, Abstract, Figures, Appendices or otherwise) shows by way of illustration various embodiments in which the claimed innovations may be practiced. The advantages and features of the application are of a representative sample of embodiments only, and are not exhaustive or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural or topological modifications may be made without departing from the scope or spirit of the disclosure. As such, all examples or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical or topological structure of any combination of any program components (a component collection), other components or any present feature sets as described in the figures or throughout are not limited to a fixed operating order or arrangement, but rather, any disclosed order is exemplary and all equivalents, regardless of order, are contemplated by the disclosure. Furthermore, it is to be understood that such features are not limited to serial execution, but rather, any number of threads, processes, services, servers, or the like that may execute asynchronously, concurrently, in parallel, simultaneously, synchronously, or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, or the like thereof. As such, it should be understood that advantages, embodiments, examples, functional, features, logical, operational, organizational, structural, topological, or other aspects of the disclosure are not to be considered limitations on the disclosure as defined by the claims or limitations on equivalents to the claims.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

The methods, systems, computer programs and mobile devices of the present disclosure, as described above and shown in the drawings, among other things, provide for improved data analysis methods, systems and machine readable programs for carrying out the same to support retaining of renters in a property. It will be apparent to those skilled in the art that various modifications and variations can be made in the devices, methods, software programs and mobile devices of the present disclosure without departing from the spirit or scope of the disclosure. Thus, it is intended that the present disclosure include modifications and variations that are within the scope of the subject disclosure and equivalents.

What is claimed is:

1. A computer implemented method of managing an online rewards program for a property manager to retain an existing renter, comprising:
receiving a rental payment from an existing renter via processor;
determining a reward to award to the existing renter via processor;
preparing and transmitting a communication to the existing renter via processor describing the reward, wherein the communication includes instructions to display on at least one application interface depicting a description of the reward.

2. The computer implemented method of claim 1, wherein the reward is a security token on a blockchain.

3. The computer implemented method of claim 1, wherein the reward is an investment of a predetermined portion of the existing renter's rent, and further wherein the method further comprises:
computing a profit of the investment over a first time period via processor; and
vesting a portion of the profit to the renter via processor after a predetermined rental period has elapsed.

4. The computer implemented method of claim 3, further comprising:
computing the renter's return on rent; and
preparing and transmitting a communication to the existing renter via processor describing the return on rent earned by the renter.

5. The computer implemented method of claim 1, wherein the reward is determined at least in part by:
referencing a renter loyalty engine;
analyzing housing units available in a real estate portfolio, needs of current renters within the rewards program, financial needs of the renter's rental unit, and the financial needs of a real estate portfolio including the renter's rental unit via processor; and
making a recommendation to a property manager of the reward for the renter.

6. The computer implemented method of claim 1, further comprising performing predictive analytics via processor based on collected data about the renter and the rental market to predict the likelihood of (i) the renter renewing their lease (ii) whether a renter wishes to move out at the end of their lease, and (iii) the likely desired size and location of a new rental unit for the renter.

7. The computer implemented method of claim 1, wherein the reward is determined via processor based at least in part on which facilities in the renter's building is using or is not using.

8. The computer implemented method of claim 1, wherein the reward is determined via processor based at least in part on data pertaining to the renter's location, data of facility usage by the renter, overall engagement of the renter with the rewards system, and renter web browser activity.

9. The computer implemented method of claim 8, further comprising determining the time to deliver the communication to the renter based on collecting data indicative of times that the renter accesses the rewards system.

10. The computer implemented method of claim 9, wherein the timing and content of the communication is determined via processor at least in part by routes travelled by the renter and locations frequently visited by the renter.

11. A computer implemented method of managing an online rewards program for a property manager to retain an existing renter, comprising:
receiving a rental payment from an existing renter via processor;
determining a reward to award to the existing renter via processor by:
analyzing housing units available in a real estate portfolio;
analyzing needs of renters within the rewards program;
analyzing financial needs of the renter's rental unit;
analyzing financial needs of a real estate portfolio including the renter's rental unit;
analyzing which facilities in the renter's building is using or is not using via processor;
analyzing data pertaining to the renter's location;
analyzing overall engagement of the renter with the rewards system; and
analyzing and renter web browser activity; and
performing predictive analytics via processor based on collected data about the renter and the rental market to predict the likelihood of (i) the renter renewing their lease (ii) whether a renter wishes to move out at the end of their lease, and (iii) the likely desired size and location of a new rental unit for the renter;
making a recommendation to a property manager of the reward for the renter;
determining a time to deliver a communication to the renter describing the reward based on collecting data indicative of times that the renter accesses the rewards system and routes travelled by the renter and locations frequently visited by the renter; and
preparing and transmitting the communication to the existing renter via processor describing the reward, wherein the communication includes instructions to display on at least one application interface depicting a description of the reward

12. A computing device comprising:
one or more computer processor circuits and one or more non-transitory machine readable storage mediums storing a set of instructions that when executed by the one or more computer processor circuits, cause the computing device to:
select a task to be performed by a renter;
prepare and forward a request to the renter to perform the task.

13. The computing device of claim 12, wherein the request includes instructions for performing the task.

14. The computing device of claim 13, further comprising instructions to process task completion data received from the renter via processor.

15. The computing device of claim 14, further comprising instructions to provide a reward to the renter responsive to receipt of the task completion data.

16. The computing device of claim 15, wherein the reward is provided automatically in response to receiving the task completion data.

17. The computing device of claim 14, wherein the task completion data includes a photograph evidencing completion of the task including a time stamp and geocoordinates for where the photo was taken.

18. The computing device of claim 17, further comprising instructions to initiate payment to the renter of a reward if the geocoordinates or time stamp meet predetermined criteria associated with the maintenance task.

19. The computing device of claim 14, wherein the task completion data includes data obtained by the renter from a QR code at a location where the maintenance task was performed.
